(19) United States
(12) Patent Application Publication
(10) Pub. No.: US 2016/0213190 A1
(43) Pub. Date: Jul. 28, 2016

(54) AN INSULATED ARTICLE

(71) Applicant: D & A CONCEPT DESIGN LIMITED, Blackrock, County Dublin (IE)

(72) Inventors: Anthony Doyle, Blackrock, County Dublin (IE); David Doherty, Blackrock, County Dublin (IE)

(21) Appl. No.: 14/917,207

(22) PCT Filed: Apr. 25, 2014
(86) PCT No.: PCT/EP2014/058522

§ 371 Date: Mar. 7, 2016

(30) Foreign Application Priority Data
Sep. 6, 2013 (GB) 1315960.3

(51) Int. Cl. A47J 27/21; A47J 41/00; B65D 81/38; F24H 1/00; F24H 9/02; A47J 36/36; F24C 15/34

(52) U.S. Cl. CPC A47J 27/21166; A47J 36/36; A47J 41/0072; F24C 15/34; F24H 1/0036; F24H 9/02; B65D 81/38

(57) ABSTRACT

This invention relates to an insulated article. The insulated articles comprise either a twin walled construction and/or a protective pouch of packaging material encompassing a layer of insulating material. The insulating material comprises an aerogel material such as silica aerogel material and the function of the insulation is to minimize energy usage in the articles. One particularly preferred article is an oven constructed with an inner and an outer wall and a layer of aerogel insulation encapsulated in a packaging material therebetween. A transparent insulation may be used for the front door of the oven or alternatively a camera capturing images inside the oven may be provided in conjunction with a visual display for displaying the images captured by the camera. The energy consumption of the oven is reduced significantly. Similar techniques can also be applied to other articles of manufacture including hot water cylinders, beverage and food containers, radiators and fireplace surrounds to name a few.

### TECHNICAL FIELD

This invention relates to insulated articles.

### BACKGROUND ART

It has been known for many years to insulate articles such as, but not limited to, hot water cylinders and beverage containers. Typically, water cylinders are provided with an external jacket of insulating material that surrounds the cylinder and beverage containers are provided with a double outer skin with an evacuated chamber intermediate the skins. The insulation allows the contents of the article to remain at the desired temperature for longer. Furthermore, the insulation obviates the possibility of individuals burning their hands when handling the articles.

There are problems however with many of the known insulated articles. First of all, beverage containers that have an evacuated chamber between a double outer skin have been known to explode violently if subjected to a significant impact. Secondly, lagging jackets of insulating material are often unsightly and if they are physically separate from the water cylinder, they can be difficult to install when the water cylinder is in situ. Thirdly, the known techniques for insulating articles described above are not suitable for many articles of manufacture that may benefit from being provided with insulation.

It is an object of the present invention to provide insulated articles that overcome at least some of the problems associated with the known insulated articles. It is a further object of the present invention to provide insulated articles that offer a useful alternative choice to the consumer.

### SUMMARY OF INVENTION

According to the invention there is provided an oven comprising a walled enclosure having a sealable aperture providing an access passageway to the interior of the walled enclosure, and a door for selectively sealing the sealable aperture, a heating element, a thermostat and a heating element controller responsive to the thermostat, characterised in that the walls of the walled enclosure and the door each comprise an inner layer, an outer layer, and an insulation layer intermediate the inner layer and the outer layer, in which the insulation layer comprises an aerogel material encapsulated in a packaging material.

By having such an oven with an aerogel material insulation layer intermediate the inner and outer layers of the oven walls and door, there will be provided a highly efficient and energy saving oven. Once the oven is up to the desired temperature, the heating element can be switched off and the contents in the oven will continue to cook at or near the set temperature for longer than would otherwise be the case. The oven will maintain the desired temperature for longer thereby requiring less electricity to power the oven and also requiring the heating element in the oven to be switched on and off less frequently, improving the longevity of the oven components and reducing the maintenance costs. Furthermore, by providing an insulation layer comprising an aerogel material encapsulated in a packaging material, it will be possible to handle the aerogel material with greater ease the manufacture of the oven will be facilitated. Furthermore, the packaging material may provide additional insulation to the oven.

In one embodiment of the invention there is provided an oven in which the aerogel material comprises silica aerogel. Silica aerogel is seen as particularly useful due to the fact that it is flexible and can withstand very high temperatures. Preferably, the aerogel is coated with a high temperature silicon spray to keep the dust levels down during manufacture.

In one embodiment of the invention there is provided an oven in which the aerogel material is glass fibre silica aerogel.

In one embodiment of the invention there is provided an oven in which the aerogel material is glass fibre continuous filament silica aerogel. By using a glass fibre continuous filament aerogel, the aerogel will be more pliable and easier to manipulate in the manufacturing process.

In one embodiment of the invention there is provided an oven in which the silica aerogel is one of a mat silica aerogel and a fabric silica aerogel.

In one embodiment of the invention, there is provided an oven in which the packaging material comprises a metal foil material. In a further embodiment of the invention, the packaging material comprises a Teflon® coated fabric material.

In one embodiment of the invention there is provided an oven in which the insulation layer of the door comprises transparent silica aerogel and the packaging material is transparent. By using a transparent silica aerogel, it will be possible to insulate the front door of the oven and still allow the goods inside the oven to be viewed during the cooking process without having to open the door. This is a significant improvement on the existing offerings.

In one embodiment of the invention there is provided an oven in which the heating element comprises an infra-red heating element.

In one embodiment of the invention there is provided an oven in which there is provided a camera mounted inside the oven and a visual display in communication with the camera and operable to display the image captured by the camera. This is seen as a useful alternative to providing a viewing window in the front door of the oven and will allow translucent aerogel, foil and other materials to be used in the insulation layer in the oven door.

In one embodiment of the invention there is provided a water heater comprising a water container comprising a charging aperture for cold water, a discharge aperture for hot water, and a heating element for heating water in the container, the water container comprising an inner wall, an outer wall, and an insulation layer therebetween, and in which the insulation layer comprises an aerogel material encapsulated in a packaging material.

This is seen as a useful article to provide with enhanced insulation. The water heater will have a twin skin with an insulation layer encapsulated in a packaging material between the skin layers thereby reducing the energy used heating and importantly reheating water in the water heater. Furthermore, the water heater will be relatively simple to construct even though it utilizes aerogel material.

In one embodiment of the invention there is provided a water heater in which the aerogel material comprises silica aerogel.

In one embodiment of the invention there is provided a water heater in which the aerogel material is glass fibre silica aerogel.

In one embodiment of the invention there is provided a water heater in which the aerogel material is glass fibre continuous filament silica aerogel.

In one embodiment of the invention there is provided a water heater in which the silica aerogel is one of a mat silica aerogel and a fabric silica aerogel.

In one embodiment of the invention, there is provided a water heater in which the packaging material comprises a metal foil material. In a further embodiment of the invention, the packaging material comprises a Teflon® coated fabric material.

In one embodiment of the invention there is provided a water heater in which the water heater is one of an immersion water heater and a billy boiler water heater.

In one embodiment of the invention there is provided a liquid container comprising an aperture for charging and discharging liquid to and from the container, and a closure for the aperture selectively operable to substantially seal the container or in the alternative to allow the filling or emptying of the liquid container, the liquid container comprising an inner wall, an outer wall, and an insulation layer therebetween, the closure comprising an inner closure wall, an outer closure wall and an insulation layer therebetween, and in which the insulation layers each comprise an aerogel material encapsulated in a packaging material.

This is also seen as a useful article to provide with enhanced insulation. The liquid container and an associated closure will have a twin skin with an insulation layer between the skin layers thereby reducing the energy loss (or gain) of the contents of the liquid container, keeping them at the desired temperature for longer.

In one embodiment of the invention there is provided a liquid container in which the aerogel material comprises silica aerogel.

In one embodiment of the invention there is provided a liquid container in which the aerogel material is glass fibre silica aerogel.

In one embodiment of the invention there is provided a liquid container in which the aerogel material is glass fibre continuous filament silica aerogel.

In one embodiment of the invention there is provided a liquid container in which the silica aerogel is one of a mat silica aerogel and a fabric silica aerogel.

In one embodiment of the invention, there is provided a liquid container in which the packaging material comprises a metal foil material. In a further embodiment of the invention, the packaging material comprises a Teflon® coated fabric material.

In one embodiment of the invention there is provided a liquid container in which the liquid container is a flask.

In one embodiment of the invention there is provided a food storage container comprising an aperture for charging and discharging food to and from the container, and a closure for the aperture selectively operable to substantially seal the container or in the alternative to allow the filling or emptying of the food storage container, the food storage container comprising an inner wall, an outer wall, and an insulation layer therebetween, the closure comprising an inner closure wall, an outer closure wall and an insulation layer therebetween, and in which the insulation layers each comprise an aerogel material encapsulated in a packaging material.

This is further seen as a useful article to provide with enhanced insulation that will be of particular benefit in the catering industry. By having such an article, it will be possible to maintain prepared food or indeed frozen food at an acceptable temperature for longer without having to use a power supply or indeed provide additional apparatus for heating or cooling the food. This will reduce the expense of providing the catering and will also reduce the likelihood of food poisoning as the food will be less likely to reach unacceptable temperature levels. Furthermore, by providing the insulation layer as described, construction of the food storage container will be relatively inexpensive and relatively straightforward.

In one embodiment of the invention there is provided a food storage container in which the aerogel material comprises silica aerogel.

In one embodiment of the invention there is provided a food storage container in which the aerogel material is glass fibre silica aerogel.

In one embodiment of the invention there is provided a food storage container in which the aerogel material is glass fibre continuous filament silica aerogel.

In one embodiment of the invention there is provided a food storage container in which the silica aerogel is one of a mat silica aerogel and a fabric silica aerogel.

In one embodiment of the invention, there is provided a food storage container in which the packaging material comprises a metal foil material. In a further embodiment of the invention, the packaging material comprises a Teflon® coated fabric material.

In one embodiment of the invention there is provided a food storage container in which the food storage container is a hot plate.

In one embodiment of the invention there is provided a hot water radiator comprising a body defining an internal chamber for hot water, the body having a front face and a rear face, and in which there is provided a layer of insulation mounted adjacent the rear face of the radiator, the layer of insulation comprising a layer of aerogel material encapsulated in a packaging material.

This is seen as a particularly effective way of optimizing the heat radiating from the hot water radiators. Much of the heat emanating from a radiator is directed towards the wall on which the radiator is mounted rather than being radiated inwardly into the room where it will be best utilized. By having the layer of aerogel insulation on the rear face of the radiator, the insulation will cause more of the heat from the radiator to be delivered into the room where it will go into heating the room more effectively. This will also, over time, assist in reducing the heating costs of the installation. By having the layer of insulation enclosed in a packaging material, the insulation material will not be damaged and furthermore the insulation will not be an irritant to occupants of the installation in which it is placed.

In one embodiment of the invention there is provided a hot water radiator in which the layer of insulation is mounted on the external surface of the radiator. In this way, the aerogel material will not be subjected to the harsh environment and the liquids inside the hot water radiator. Furthermore, this will allow the insulation to be retrofit to the hot water radiator.

In one embodiment of the invention there is provided a hot water radiator in which the layer of insulation is detachably mounted on the external surface of the radiator. This will allow the layer of insulation to be retrofit to the radiators and also will allow the layer of insulation to be moved from one radiator to another which may be desirable particularly in zoned heating systems.

In one embodiment of the invention there is provided a hot water radiator in which the layer of insulation is provided with at least one clip for securing the layer of insulation to the radiator.

In one embodiment of the invention there is provided a hot water radiator in which the pouch of packaging material comprises a pouch of foil material. The foil material will assist in radiating heat inwardly into the installation.

In one embodiment of the invention there is provided a hot water radiator in which the pouch of protective material further comprises an outer layer of Teflon® coated fabric.

Teflon fabric is seen as a good choice of material to contain the insulation material. Teflon® fabric will be able to withstand temperatures of up to 265 degrees centigrade and will be flame retardant and is ideally suited for use in a domestic environment.

In one embodiment of the invention there is provided a hot water radiator in which the layer of insulation is mounted internal the body.

In one embodiment of the invention there is provided a hot water radiator in which the aerogel material comprises silica aerogel.

In one embodiment of the invention there is provided a hot water radiator in which the aerogel material is glass fibre silica aerogel.

In one embodiment of the invention there is provided a hot water radiator in which the aerogel material is glass fibre continuous filament silica aerogel.

In one embodiment of the invention there is provided a hot water radiator in which the silica aerogel is one of a mat silica aerogel and a fabric silica aerogel.

In one embodiment of the invention there is provided a fireplace surround comprising a pair of side walls bridged by a rear wall, characterised in that the walls each comprise an inner layer, an outer layer, and an insulation layer intermediate the inner layer and the outer layer, and in which the insulation layer comprises an aerogel material encapsulated in a packaging material.

Such an article is seen as highly beneficial as it will contain heat loss from the back and sides of the hearth and maximize the delivery of heat from the fire in the fireplace into the room in which the fireplace is located. Furthermore, it is envisaged that the article may improve the safety of the fireplace as often little consideration is given to what is being heated behind the fireplace and the article may reduce the likelihood of a fire starting due to materials behind the fireplace being heated by a fire in the fireplace. The packaging material will facilitate the manufacture of the fireplace surround and may also provide additional safety depending on the material chosen for the packaging material.

In one embodiment of the invention there is provided a fireplace surround in which the aerogel material comprises silica aerogel.

In one embodiment of the invention there is provided a fireplace surround in which the aerogel material is glass fibre silica aerogel.

In one embodiment of the invention there is provided a fireplace surround in which the aerogel material is glass fibre continuous filament silica aerogel.

In one embodiment of the invention there is provided a fireplace surround in which the silica aerogel is one of a mat silica aerogel and a fabric silica aerogel.

In one embodiment of the invention, there is provided a fireplace surround in which the packaging material comprises a metal foil material. In a further embodiment of the invention, the packaging material comprises a Teflon® coated fabric material. Teflon® coated fabric is seen as preferred as it will be flame retardant and may offer a further level of protection around the fireplace and will obviate the possibility of a fire starting behind the fireplace.

In one embodiment of the invention there is provided a lagging jacket for a hot water cylinder comprising an insulation layer housed in a pouch of packaging material and means to secure the lagging jacket in position relative to a hot water cylinder, the insulation layer comprising an aerogel material. Aerogel is seen as a particularly suited material to use as a lagging jacket as it is a good insulator and can be flexible in construction. By packaging the aerogel in a packaging material, it will be possible to handle the aerogel material with greater ease and manufacturing costs will be reduced.

In one embodiment of the invention there is provided a lagging jacket for a hot water cylinder in which the pouch of protective material comprises a pouch of foil material.

In one embodiment of the invention there is provided a lagging jacket for a hot water cylinder in which the pouch of protective material further comprises an outer layer of Teflon® fabric.

In one embodiment of the invention there is provided a lagging jacket for a hot water cylinder in which the aerogel material comprises silica aerogel.

In one embodiment of the invention there is provided a lagging jacket for a hot water cylinder in which the aerogel material is glass fibre silica aerogel.

In one embodiment of the invention there is provided a lagging jacket for a hot water cylinder in which the aerogel material is glass fibre continuous filament silica aerogel.

In one embodiment of the invention there is provided a lagging jacket for a hot water cylinder in which the silica aerogel is one of a mat silica aerogel and a fabric silica aerogel.

### BRIEF DESCRIPTION OF THE DRAWINGS

The invention will now be more clearly understood from the following description of some embodiments thereof given by way of example only with reference to the accompanying drawings, in which:

FIG. 1 is a diagrammatic perspective view of an oven according to the invention;

FIG. 2 is a diagrammatic perspective view of a second embodiment of oven according to the invention;

FIG. 3 is a diagrammatic perspective view of an immersion heater according to the invention;

FIG. 4 is a diagrammatic perspective view of a flask according to the invention;

FIG. 5 is a diagrammatic plan view of a food storage container according to the invention;

FIG. 6 is a diagrammatic perspective view of a radiator according to the invention;

FIG. 7 is perspective view of an insulation layer for a radiator according to the invention;

FIG. 8 is a diagrammatic perspective view of a fireplace according to the invention; and

FIG. 9 is a perspective view of a lagging jacket according to the invention.

### DETAILED DESCRIPTION OF THE DRAWINGS

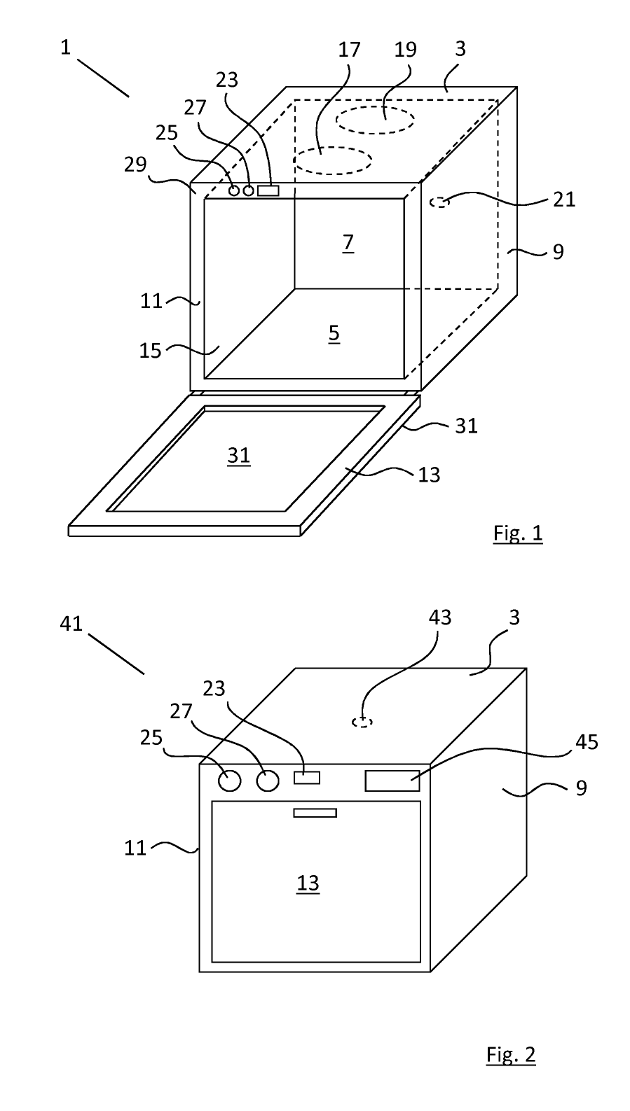

Referring to FIG. 1, there is shown an insulated article, in this instance an oven, indicated generally by the reference numeral 1, comprising a substantially cuboid body having a top wall 3, a bottom wall 5, a rear wall 7, a pair of side walls 9, 11 and a front door 13 operable to selectively seal an aperture 15 which provides an access passageway into the interior of the oven 1. The oven comprises a pair of heating elements, in this case infra-red lamps 17, 19, a thermostat 21 and a heating element controller 23 responsive to the thermostat and operable to control the heating elements 17, 19. A control panel having controls 25, 27 such as those commonly known in the art is provided on the front of the oven 1 to allow selection of oven function and desired temperature.

The walls 3, 5, 7, 9, 11 and the front door 13 each comprise an inner layer and an outer layer and an insulation layer 29, 31 respectively intermediate the inner layer and the outer layer. The insulation layer comprises an aerogel material, in this case silica aerogel material. The insulation layer 31 in the door 13 comprises, at least in part, transparent silica aerogel, to allow food cooking inside the oven to be viewed through the transparent insulation layer as the food cooks without the chef having to open the door.

The insulation layers are covered in a packaging material (not shown) which may be either a metal foil material such as an aluminium (silver) foil or similar type of foil and/or a Teflon® fabric or a Teflon® coated fabric. The insulation layer 31 in the door 13 may be covered with a transparent packaging material such as a transparent plastic wrap. In addition to providing a Teflon® coated fabric, other coatings could be provided on the fabric packaging material that would contain the dust particles from the aerogel material. In this way, handling of the aerogel will be facilitated.

Referring to FIG. 2, there is shown an alternative embodiment of oven, indicated generally by the reference numeral 41, where like parts have been given the same reference numeral as before. The oven 41 differs from the oven 1 illustrated in FIG. 1 in that the insulation layer 31 in the door is not constructed from a transparent silica aerogel and instead there is provided a camera 43 and a monitor 45 in communication with the camera 43 and operable to display the images captured by the camera.

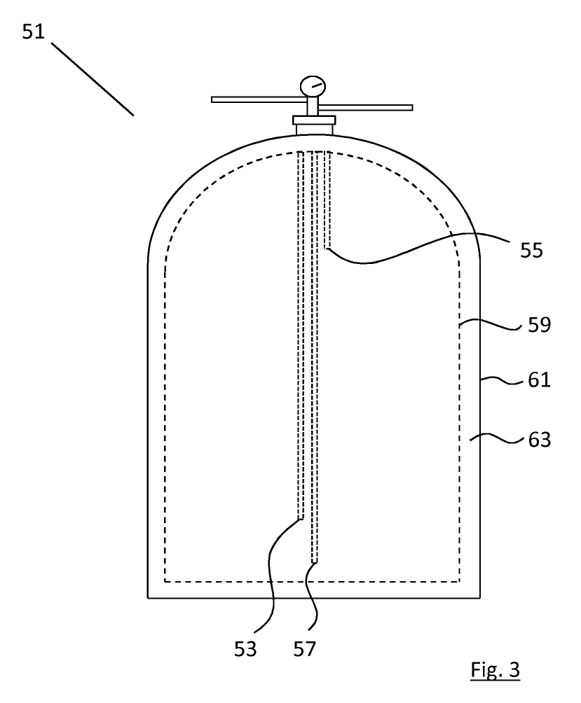

Referring to FIG. 3, there is shown a further insulated article, in this instance a hot water cylinder, more specifically an immersion tank, indicated generally by the reference numeral 51. The immersion tank 51 comprises a charging aperture 53 for cold water, a discharge aperture 55 for hot water, and a heating element 57 for heating water in the tank. The immersion tank 51 comprises an inner wall 59 shown in dashed outline, an outer wall 61, and an insulation layer 63 of aerogel material therebetween. The insulation layer of aerogel material is packaged in a packaging material such as metal foil and/or Teflon® coated fabric.

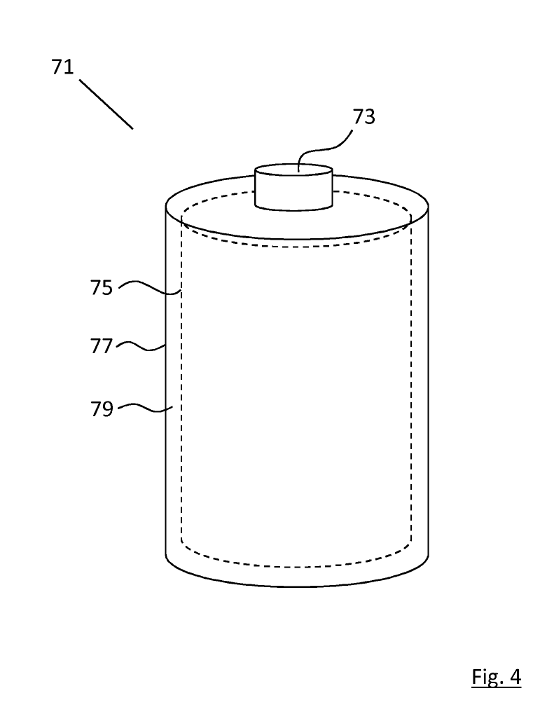

Referring to FIG. 4, there is shown a diagrammatic representation of another insulated article according to the present invention, in this case a liquid container, more specifically a flask, indicated generally by the reference numeral 71. The flask 71 comprises an aperture (not shown) for charging and discharging liquid to and from the container, and a closure 73 for the aperture selectively operable to substantially seal the flask or in the alternative to allow the filling or emptying of the liquid container. The flask 71 comprises an inner wall 75 shown in dashed outline, an outer wall 77, and an insulation layer 79 encapsulated in a packaging material therebetween. The closure 73 also comprises an inner closure wall, an outer closure wall and an insulation layer encapsulated in a packaging material therebetween. The insulation layers in the closure 73 and the main flask body 71 each comprise an aerogel material.

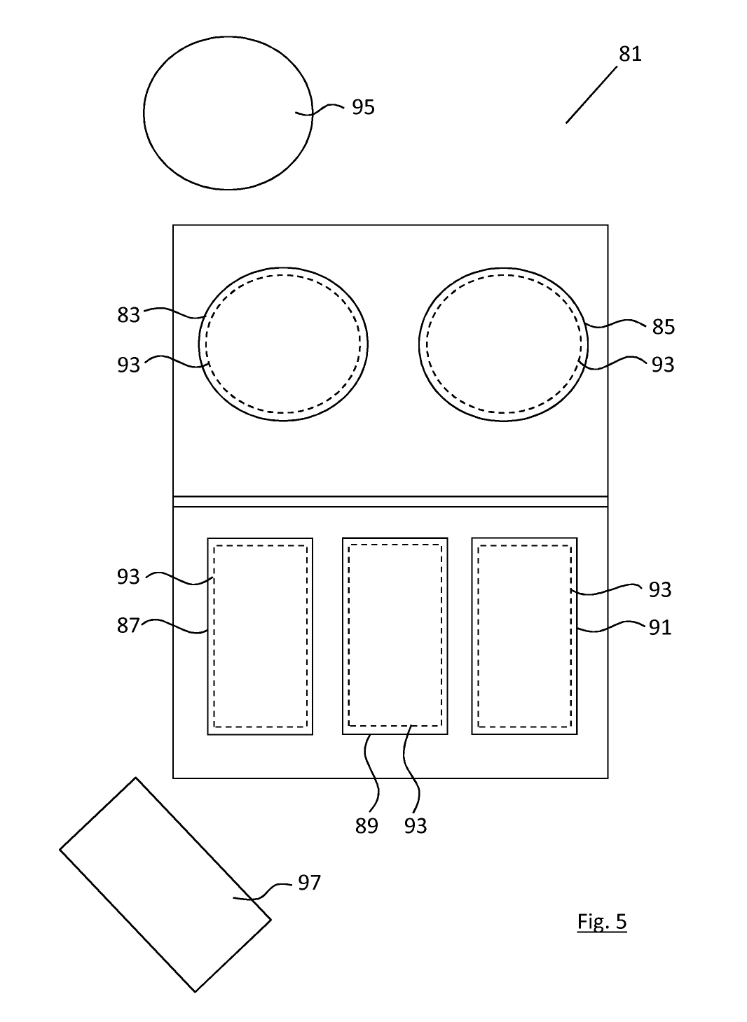

Referring to FIG. 5, there is shown a diagrammatic representation of a further still insulated article according to the present invention, in this case a food storage container, indicated generally by the reference numeral 81. The food storage container 81 comprises a plurality of compartments 83, 85, 87, 89, 91. The compartments each comprise an inner wall illustrated by dashed outline, an outer wall illustrated by solid outline, and an insulation layer 93 encapsulated in a packaging material therebetween. A pair of closures is shown, a first closure 95 for the compartment 83 and a second closure 97 for the compartment 87. The remaining compartments 85, 89, 91 are also provided with suitable closures (not shown). The closures 95, 97 each comprise an inner closure wall, an outer closure wall and an insulation layer therebetween. The insulation layer 93 and the insulation layer between the outer closure wall and inner closure wall of the closure each comprise an aerogel material encapsulated in a packaging material, such as a metal foil and/or a Teflon® coated fabric. In the embodiment shown, the compartments are provided in a number of different shapes and sizes. If desired, the compartments may all be of the same size as each other or indeed there could be other sizes and shapes of compartment than those shown in FIG. 5.

Referring to FIG. 6, there is shown a diagrammatic representation of another still insulated article according to the present invention, in this case a hot water radiator, indicated generally by the reference numeral 101. The hot water radiator comprises a body 103 defining an internal chamber (not shown) for hot water, the body 103 having a front face 105 and a rear face 107. There is further provided a layer of insulation 109 mounted adjacent the rear face 107 of the radiator 101, the layer of insulation 109 comprising a layer of aerogel material encapsulated in a packaging material. The radiator thus described will encourage the heat of the radiator to be radiated outwardly from the front face 105 of the radiator rather than being wasted by being radiated backwards through the rear face 107.

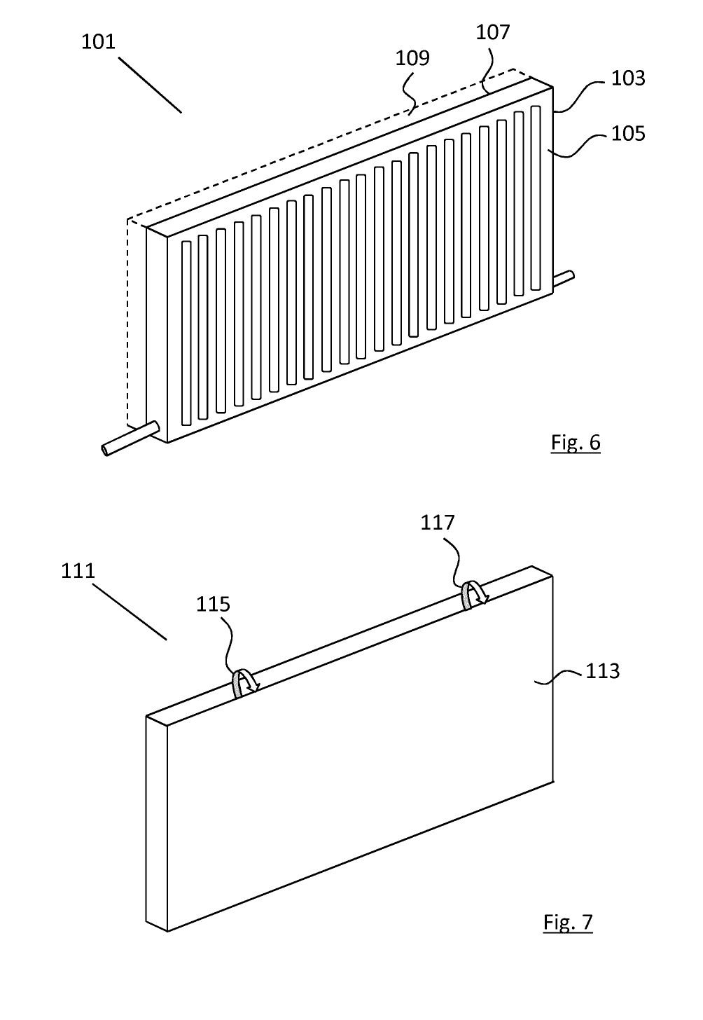

Referring to FIG. 7, there is shown a diagrammatic representation of an insulation layer for a radiator, indicated generally by the reference numeral 111. The insulation layer 111 comprises a sheet of aerogel material, preferably a glass fibre continuous filament silica aerogel in either mat or fabric layer form, encased in a pouch 113 of Teflon (Registered Trade Mark ®) fabric. The insulation layer 111 comprises a pair of hooks 115, 117 for mounting the insulation layer on a radiator. It is envisaged that this embodiment will be particularly suited for zoned heating installations where radiators in one or more rooms may be on at different times to other radiators and the construction shown will allow the insulation layer to be moveable to a desired location.

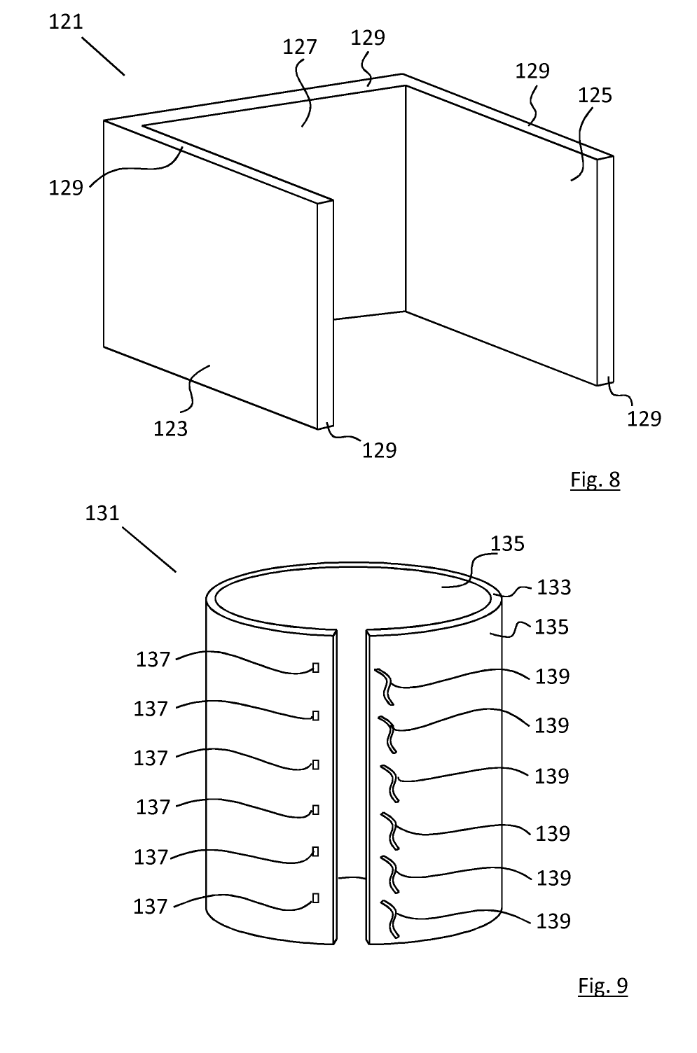

Referring to FIG. 8, there is shown a diagrammatic representation of another still insulated article according to the present invention, in this case a fireplace surround, indicated generally by the reference numeral 121. The fireplace surround 121 comprises a pair of side walls 123, 125 bridged by a rear wall 127. The side walls 123, 125 and the rear wall 127 each comprise an inner layer, an outer layer, and an insulation layer 129 encapsulated in a packaging material intermediate the inner layer and the outer layer. Again, the insulation layer 129 comprises an aerogel material, preferably silica aerogel, ideally glass fibre silica aerogel and the packaging material comprises a metal foil and/or a Teflon® coated fabric. In use, the fireplace surround 121 can be placed behind and surrounding the fireplace (not shown) so that heat from the fireplace is directed forwards and outwardly into the room in which the fireplace is located.

Referring to FIG. 9, there is shown a diagrammatic representation of another insulated article, in this case a lagging jacket for a hot water cylinder, indicated generally by the reference numeral 131. The lagging jacket comprises an insulation layer 133 housed in a pouch 135 of packaging material. There is provided means to secure the lagging jacket 131 in position relative to a hot water cylinder (not shown), in this case provided by way of buckles 137 and straps 139. The insulation layer comprising an aerogel material. If desired, the lagging jacket may taper inwardly at the top of the lagging jacket and/or a draw-string (not shown) may be provided around the top of the lagging jacket to draw the top of the lagging jacket inwardly to encapsulate a hot water cylinder (not shown).

In this specification the terms “comprise, comprises, comprised and comprising” and the terms “include, includes, included and including” are all deemed totally interchangeable and should be afforded the widest possible interpretation.

The invention is in no way limited to the embodiments hereinbefore described but may be varied in both construction and detail within the scope of the appended claims.

1) An oven comprising a walled enclosure having a sealable aperture providing an access passageway to the interior of the walled enclosure, and a door for selectively sealing the sealable aperture, a heating element, a thermostat and a heating element controller responsive to the thermostat, characterised in that the walls of the walled enclosure and the door each comprise an inner layer, an outer layer, and an insulation layer intermediate the inner layer and the outer layer, in which the insulation layer comprises an aerogel material encapsulated in a packaging material.

2) The oven as claimed in claim 1 in which the aerogel material comprises silica aerogel.

3) The oven as claimed in claim 1 in which the aerogel material is glass fibre silica aerogel.

4) The oven as claimed in claim 1 in which the aerogel material is glass fibre continuous filament silica aerogel.

5) The oven as claimed in any of claim 2 in which the silica aerogel is one of a mat silica aerogel and a fabric silica aerogel.

6) The oven as claimed in claim 1 in which the packaging material encapsulating the aerogel material comprises a metal foil material.

7) The oven as claimed in claim 1 in which the packaging material encapsulating the aerogel material comprises a Teflon® coated fabric.

8) The oven as claimed in claim 2 in which the insulation layer of the door comprises transparent silica aerogel and the packaging material is transparent.

9) The oven as claimed in claim 1 in which the heating element comprises an infra-red heating element.

10) The oven as claimed in claim 1 in which there is provided a camera mounted inside the oven and a visual display in communication with the camera and operable to display the image captured by the camera.

11) A water heater comprising a water container comprising a charging aperture for cold water, a discharge aperture for hot water, and a heating element for heating water in the container, the water container comprising an inner wall, an outer wall, and an insulation layer therebetween, and in which the insulation layer comprises an aerogel material encapsulated in a packaging material.

12-14) (canceled)

15) The water heater as claimed in claim 11 in which the aerogel material comprises silica aerogel and the silica aerogel is one of a mat silica aerogel and a fabric silica aerogel.

16) The water heater as claimed in claim 11 in which the packaging material encapsulating the aerogel material comprises one of a metal foil material and a Teflon® coated fabric.

17-26) (canceled)

27) A food storage container comprising an aperture for charging and discharging food to and from the container, and a closure for the aperture selectively operable to substantially seal the container or in the alternative to allow the filling or emptying of the food storage container, the food storage container comprising an inner wall, an outer wall, and an insulation layer therebetween, the closure comprising an inner closure wall, an outer closure wall and an insulation layer therebetween, and in which the insulation layers each comprise an aerogel material encapsulated in a packaging material.

28-30) (canceled)

31) The food storage container as claimed in claim 27 in which the aerogel material comprises silica aerogel and in which the silica aerogel is one of a mat silica aerogel and a fabric silica aerogel.

32) A food storage container as claimed in claim 27 in which the packaging material encapsulating the aerogel material comprises one of a metal foil material and a Teflon® coated fabric.

33-34) (canceled)

35) A hot water radiator comprising a body defining an internal chamber for hot water, the body having a front face and a rear face, and in which there is provided a layer of insulation mounted adjacent the rear face of the radiator, the layer of insulation comprising a layer of aerogel material encapsulated in a packaging material.

36) The hot water radiator as claimed in claim 35 in which the layer of insulation is mounted on the external surface of the radiator.

37-38) (canceled)

39) The hot water radiator as claimed in claim 35 in which the packaging material comprises one of a pouch of foil material and an outer layer of Teflon® coated fabric.

40) (canceled)

41) The hot water radiator as claimed in claim 35 in which the layer of insulation is mounted internal the body.

42-52) (canceled)

53) A lagging jacket for a hot water cylinder comprising an insulation layer housed in a pouch of packaging material and means to secure the lagging jacket in position relative to a hot water cylinder, the insulation layer comprising an aerogel material.

54-58) (canceled)

59) The lagging jacket for a hot water cylinder as claimed in claim 53 in which the aerogel material comprises silica aerogel and in which the silica aerogel is one of a mat silica aerogel and a fabric silica aerogel.
